(19) United States
(12) Patent Application Publication
(10) Pub. No.: US 2026/0273899 A1
(43) Pub. Date: Sep. 17, 2026

(54) CLAD STEEL PLATE AND MANUFACTURING METHOD THEREFOR

(71) Applicant: BAOSHAN IRON & STEEL CO., LTD., Shanghai (CN)

(72) Inventors: Zhao Xing, Shanghai (CN); Xiaojun Liang, Shanghai (CN); Yingmin Hao, Shanghai (CN); Sihai Jiao, Shanghai (CN); Wei Kong, Shanghai (CN); Guilin Xiao, Shanghai (CN)

(21) Appl. No.: 19/147,929

(22) PCT Filed: Jan. 23, 2024
(86) PCT No.: PCT/CN2024/073614

§ 371 Date: Jul. 14, 2025

(30) Foreign Application Priority Data
Jan. 31, 2023 (CN) 202310084254.5

(51) Int. Cl. B32B 15/01; B32B 37/10; C22C 38/00; C22C 38/02; C22C 38/04; C22C 38/42; C22C 38/58

(52) U.S. Cl. CPC B32B 15/011; B32B 37/1018; C22C 38/002; C22C 38/02; C22C 38/04; C22C 38/42; C22C 38/58

(57) ABSTRACT

The present invention provides a clad steel plate, comprising a base layer and a cladding layer on the base layer, wherein the clad steel plate has a thickness of 60-120 mm, the cladding layer is made of stainless steel, the base layer is made of carbon steel, and a bonding strength between the base layer and the cladding layer is 500 MPa or more. The clad steel plate of the present invention exhibits excellent tensile performance, low-temperature impact performance, and interlayer bonding performance. The present invention also provides a method for manufacturing the clad steel plate.

### TECHNICAL FIELD

The present invention relates to the technical field of clad steel plate, in particular to a clad steel plate and a manufacturing method therefor.

### BACKGROUND ART

Under harsh media environments, such as seawater with high chloride ion content, flue gas pipelines with complex media components, pressurized and temperature-bearing oil and gas pipelines, and chemical transportation containers, it is necessary to select stainless steel materials with excellent corrosion resistance.

By employing clad steel plates, material design can prioritize the base layer carbon steel to ensure structural strength and toughness, realizing requirements for different strength and toughness; and realize corrosion resistance of the material by stainless steel cladding layer. Therefore, the clad steel plate can realize the advantageous performance of two materials at the same time. Through clad steel plate design, larger gauges of clad steel plate can be provided, reducing welded seams required for connecting steel plates, and reducing risks of localized failure introduced during the welding process. Additionally, the use of clad steel plates transforms the previously required welding between carbon steel and stainless steel into welding between carbon steel and the clad steel plate's carbon steel, or welding between carbon steel and clad steel plate as a whole. This ensures that the main material involved in fusion welding remains carbon steel, not only reducing costs but also simplifying welding quality control. Production efficiency is therefore enhanced.

Heterogeneous clad plates, which combine characteristics of two or more materials, exhibit broad application prospects, particularly when two sides of the steel plate face different service environments or when a single material cannot meet specific performance requirements. Heterogeneous clad plate is a very ideal choice in such cases. Compared to explosive cladding, which is limited by factors such as explosive sites and environmental pollution, welding-rolling cladding achieves metallurgical bonding of materials through conventional hot rolling.

At the same time, due to repeated rolling at high temperatures, the clad interface offers advantages over explosive cladding interfaces, such as stronger bonding strength and fewer cladding defects.

Traditional hydropower steel plates, to meet corrosion or wear resistance requirements while ensuring the overall structural strength of the equipment, typically employ surfacing welding or rivet welding methods to metallurgically bond the corrosion-resistant or wear-resistant layer metal with the base material. However, this approach may introduce welding defects and necessitate subsequent heat treatment of processed components to relieve stress, leading to relatively low overall production efficiency. The use of heterogeneous clad plates can solve the above problems. However, since the steel plate after cladding should conduct component processing, such as bending, cutting, etc., the clad plate needs to have excellent structural performance, along with high shear strength and bonding strength to ensure the material's processibility.

The current production technology for cladding extra-thick plate is mostly homogeneous cladding or adopt symmetric plate assembly methods to control plate flatness. For heterogeneous cladding, due to differences or significant disparities in physical properties of the cladding and base layers, warpage issues are prone to occur during the rolling process, hindering smooth production. Furthermore, for hydropower steel plates, they must exhibit sufficient corrosion resistance and strength to withstand water flow erosion during service, as well as adequate shear strength to avoid material tearing during processing.

Chinese patent application CN201610203545.1 discloses a 160 mm extra-thick steel plate with excellent low-temperature toughness and a manufacturing method therefor. By adopting two 300 mm-thick continuous casting slabs for homogeneous cladding, followed by rolling under high reduction and normalizing treatment, an extra-thick steel plate with improved low-temperature toughness is obtained.

Chinese patent application CN201710520635.8 discloses a low-alloy extra-thick steel plate with excellent internal quality, low-temperature impact toughness, and resistance to lamellar tearing produced by cladding two slabs. By using 370 mm or 450 mm thick continuous casting slabs, electron beam welding, cladding rolling, and normalizing treatment, an extra-thick steel plate meeting the flaw detection requirements and possessing specific low-temperature toughness is obtained.

The above two patents fall within the category of homogeneous cladding.

Chinese patent application CN201610211275.9 discloses a manufacturing method for a stainless steel-carbon steel extra-thick heterogeneous clad plate. By embedding stainless steel into carbon steel grooves, sequentially stacking carbon steel, stainless steel, stainless steel, and carbon steel, applying an isolating agent between the two stainless steel layers to form a clad slab, then rolling the clad slab to obtain a heterogeneous clad steel plate.

Chinese patent application CN201810890483.5 discloses an extra-thick clad steel plate with high shear strength for third-generation nuclear power plants and a manufacturing method therefor. By sequentially stacking stainless steel, carbon steel, carbon steel, and stainless steel, applying an isolating agent between the two carbon steel layers to form a clad slab, performing four-edge sealed welding and rolling on the clad slab, and then subjecting it to quenching and tempering treatment, a clad plate for nuclear power plants with a finished thickness of 29-100 mm is obtained.

Chinese patent application CN201810890483.5 discloses a manufacturing method for an extra-thick stainless steel clad plate. By placing two stainless steel plates into a nesting, then covering them with base material carbon steel for assembly welding, upper and lower heterogeneous extra-thick stainless steel clad plates are obtained. This method belongs to heterogeneous cladding, but due to the use of a multi-layer slab assembly method, it has certain limitations on the finished plate thickness. The specification provides no detailed elaboration on the performance of steel plate after cladding, and thus the application scenarios remain unclear.

The manufacturing methods of the extra-thick plates involved in the above patent applications are either homogeneous cladding or heterogeneous symmetric cladding. Homogeneous cladding cannot solve the problem of different application scenarios of clad steel plate material on two sides, thereby their application environment is limited. While heterogeneous symmetric cladding can resolve this issue, it employs symmetric upper-lower slab assembly, resulting in a relatively large slab thickness, which typically reaches 600-1000 mm. This approach imposes high demands on equipment load and the mill's maximum rolling thickness capacity, leading to poor production line adaptability, which is not conducive to mass production. At the same time, due to the multi-layer symmetric slab assembly rolling method, issues such as insufficient core material cooling may arise, which can cause carbide precipitation in stainless steel, degrading corrosion resistance. Furthermore, performance adjustments cannot be achieved via online water cooling, which needs to be adjusted by a series of subsequent heat treatment methods, thereby increasing production costs and other issues.

WO2020/134675A1 discloses a corrosion-resistant marine clad steel plate and a manufacturing method thereof. The corrosion-resistant clad steel plate has a two-layer structure, with one layer being duplex stainless steel and the other being carbon steel. It is rolled via a double-barrier vacuum slab assembly method, exhibiting good structural strength, excellent corrosion resistance, and simultaneously realizing structural weight reduction. However, the bonding strength at the stainless steel-carbon steel interface still has room for further improvement.

The field still requires a clad steel plate that not only possesses excellent tensile performance and low-temperature impact performance but also demonstrates superior interlayer bonding strength.

### SUMMARY

To solve the above technical problems, a first aspect of the present invention provides a clad steel plate, comprising a base layer and a cladding layer on the base layer, wherein the clad steel plate has a thickness of 60-120 mm,
the cladding layer is made of stainless steel, and the stainless steel comprises the following chemical components in mass percentage: 0<C≤0.08%, 0<Si≤1.0%, 0<Mn≤2.0%, Cr: 18.0-20.0%, Ni: 8.0-11.0%, 0<S≤0.03%, 0<P≤0.035%, with the balance being Fe and unavoidable impurities;
the base layer is made of carbon steel, and the carbon steel comprises the following chemical components in mass percentage: 0<C≤0.24%, 0<Si≤0.55%, 0<Mn≤1.60%, 0<P≤0.035%, 0<S≤0.035%, 0<Cr≤0.30%, 0<Ni≤0.30%, 0<Cu≤0.40%, with the balance being Fe and unavoidable impurities,
and a bonding strength between the base layer and the cladding layer is 500 MPa or more.

By adopting the technical solution of the present invention, through providing a diffusion layer with a specific thickness, the clad steel plate with a large thickness (60-120 mm) achieves extremely high bonding strength between the base layer and the cladding layer, while also exhibiting excellent tensile performance and low-temperature impact performance.

The stainless steel and carbon steel used in the clad steel plate of the present invention can be conventional materials in the field. For example, the stainless steel can be austenitic stainless steel, especially from the perspectives of high-temperature resistance, processing performance, and toughness, preferably 304L austenitic stainless steel, the composition of which satisfies GB/T 4237-2015 “Hot rolled stainless steel plate, sheet and strip”. The carbon steel can be a low-alloy high-strength structural steel plate. From the perspectives of high strength, high toughness, fatigue resistance, impact resistance, and weldability, etc., Q355C carbon steel is preferred, with its composition complying with GB/T 3274-2017 “Hot-rolled plates, sheets and strips of carbon structural steels and high strength low alloy structural steels”.

Preferably, the cladding layer comprises the following chemical components in mass percentage: C: 0.02-0.045%, Si: 0.3-0.6%, Mn: 1.0-1.4%, Cr: 18.0-19.0%, Ni: 8.0-9.0%, 0<P≤0.03%, 0<S≤0.01%, with the balance being Fe and unavoidable impurities.

Preferably, the base layer comprises the following chemical components in mass percentage: C: 0.03-0.1%, Si: 0.1-0.3%, Mn: 1.0-1.5%, 0<P≤0.01%, 0<S≤0.005%, Cr: 0.24-0.30%, Ni: 0.10-0.25%, Cu: 0.1-0.3%, with the balance being Fe and unavoidable impurities.

Preferably, the cladding layer (stainless steel) has an austenitic structure, with rapid cooling after rolling to prevent carbide precipitation and enhance intergranular corrosion resistance; the base layer (carbon steel) has a structure of polygonal ferrite, bainite, and a small amount of martensite-austenite islands with a volume fraction smaller than either the above polygonal ferrite or bainite, which allows the carbon steel to combine the toughness of ferrite with the strength of bainite, while the small amount of martensite-austenite islands distributed within the ferrite and bainite further improve the impact performance of the carbon steel.

Preferably, in the base layer, the ferrite has a volume fraction of 40-60%, the bainite has a volume fraction of 30-50%, the martensite-austenite islands have a volume fraction of 5-10%. More preferably, the ferrite in the carbon steel has a grain size grade of 5 or more.

Preferably, a diffusion layer exists between the base layer and the cladding layer, and the diffusion layer has an average thickness of 15-25 μm.

Preferably, in the above clad steel plate, the base layer has a yield strength of 300-550 MPa, a tensile strength of 500-600 MPa, and an impact energy at 0° C. of 200-400 J, preferably 300-400 J; and/or, the cladding layer has a yield strength of 400-500 MPa, a tensile strength of 650-750 MPa, and an impact energy at 0° C. of 200-300 J.

Preferably, in the above clad steel plate, the bonding strength of an interface between the base layer and the cladding layer is 550-650 MPa.

A second aspect of the present invention provides a method for manufacturing the above clad steel plate, comprising the following steps in sequence:
1) Assembling a slab: Preparing stainless steel and carbon steel, stacking the stainless steel and carbon steel after dimensional processing, vacuum sealing to obtain a clad slab, and evacuating the clad slab to a vacuum degree of 0.01 Pa or less;
2) Heating: Heating the clad slab to 1150-1250° C.;
3) Rolling: Including a first rolling and a second rolling, wherein the first rolling adopts longitudinal rolling with the longitudinal direction aligning with the length direction of the clab slab, and the upper layer is the stainless steel and the lower layer is the carbon steel during rolling;
then the clad slab is turned over so that the upper layer is the carbon steel and the lower layer is the stainless steel, and the second rolling is performed to obtain a rolled steel plate;
4) Cooling: First adopting a first-stage cooling on the rolled steel plate using compressed air or water, and then performing stack cooling on the rolled steel plate to obtain the clad steel plate;
The first rolling above is a multi-pass rolling, and each pass has a reduction rate of 5-10%.

The terms “first”, “second” etc., are used solely for descriptive differentiation and should not be construed as indicating or implying relative importance.

In the present invention, atomic interdiffusion at the stainless steel-carbon steel interface is achieved through rolling, forming a diffusion layer between the heterogeneous cladding and base layers, thereby obtaining the desired clad steel plate with excellent bonding strength.

A reduction rate of 10% or less avoids steel plate warpage during rolling, while multi-pass rolling with a reduction rate of 5% or more ensures sufficient mixing of the structure at the carbon steel-stainless steel clad interface, thereby guaranteeing that the bond strength of the clad interface of the steel plate after the first rolling is 500 MPa or more.

Preferably, the second rolling above is a multi-pass rolling, each pass has a reduction rate of 10-20%, and a finishing rolling temperature is 850-1000° C., preferably 870-950° C., more preferably 890-920° C.

The second rolling can adopt a relatively large reduction rate to promote the fragmentation and recrystallization of the grain. Controlling the finishing rolling temperature avoids the formation of abnormally coarse structures caused by rolling in the two-phase region. At the same time, rapid cooling to the phase transformation temperature after rolling further inhibits structure coarsening, which enhances material strength and low-temperature impact toughness through grain refinement.

Preferably, the first-stage cooling above has a starting cooling temperature of 830-1000° C., preferably 830-880° C., a cooling rate of 5-20° C./s, preferably 10-20° C./s, and a final cooling temperature of 500-650° C., preferably 500-580° C.

Preferably, in the above method, before stacking the austenitic stainless steel sheet with the carbon steel or low-alloy steel sheet and performing vacuum sealing, the surfaces of the austenitic stainless steel and carbon steel or low-alloy steel are subjected to pretreatment. The pretreatment includes removing oxide scales and contaminants. Evacuating the clad slab to a vacuum degree of 0.01 Pa or less.

In the present invention, the extra-thick clad steel plate, produced via double-layer heterogeneous cladding achieves a balance between the corrosion resistance performance of stainless steel and the mechanical performance of carbon steel. It can be widely applied to structural components used in corrosive environments such as hydropower. Compared to the prior art, it offers the following beneficial effects:
1. The adoption of a double-layer heterogeneous clad slab assembly method, compared to traditional homogeneous cladding, has broader application scenarios of the material. Compared to heterogeneous symmetric four-layer slab assembly or multi-layer slab assembly methods, it requires smaller slab dimensions, lower load demands on production equipment such as rolling mills, which enhances production line adaptability and facilitates mass production.
2. By adopting a two-stage rolling strategy, during the first rolling process, multi-pass deformation under low reduction ensures thorough bonding at the clad interface, avoiding unbonded regions caused by weld seam or interface misalignment due to large deformations. During the second rolling process, high reduction promotes fragmentation and recrystallization of original grains, achieving grain refinement strengthening and meeting the product's performance requirements.
3. Positioning the stainless steel layer as the lower layer during the second rolling effectively avoids issues such as steel plate warping and water accumulation caused by faster cooling contraction when the stainless steel is placed as the upper layer, which would otherwise deteriorate the rolled plate flatness. This significantly improves the flatness of such double-layer heterogeneous clad steel plates after rolling.
4. Since both the stainless steel layer and carbon steel layer surfaces are exposed during the water cooling process after rolling, adjusting the cooling rates of the upper and lower layers enables independent control of the performance of the stainless steel and carbon steel layer. This method outperforms the process route for heterogeneous symmetric clad steel plates, where insufficient core material cooling necessitates subsequent heat treatment for performance improvement, thus improving production efficiency. At the same time, rapid cooling inhibits carbide precipitation, thereby suppressing the formation of chromium-depleted zones at grain boundaries and reducing the intergranular corrosion susceptibility of stainless steel caused by carbide precipitation.
5. By employing stack cooling in a slow cooling pit after rolling, the tendency for hydrogen evolution at the heterogeneous material interface is reduced, further enhancing the bonding strength of the interface.

The method for manufacturing the clad steel plate of the present invention, through optimized rolling processes, achieves excellent flatness in the steel plate after rolling while ensuring that the final clad steel plate exhibits outstanding mechanical performance.

### BRIEF DESCRIPTION OF DRAWINGS

FIG. 1 shows a structure photograph of the clad steel plate of Example 1 of the present invention along its thickness direction.

FIG. 2 shows the results of Fe element line scanning along the arrow direction indicated in FIG. 1.

### DETAILED DESCRIPTION

The embodiment of the present invention will be further explained in conjunction with the Examples. Unless otherwise specified, all percentages are by mass.

### I. Clad Steel Plate

The clad steel plate of the present invention has a base layer and a cladding layer which is bonded to the surface of the base layer, and a diffusion layer between the base layer and the cladding layer.

i. Base Layer Composition

The base layer is composed of carbon steel or low-alloy steel. The carbon steel or low-alloy steel can be carbon structural steel or low-alloy steel commonly used in the field (particularly in hydropower) for pressure pipelines, pressure vessels, and hydropower (auxiliary) equipment, preferably complying with “GB/T 4237-2015 Hot rolled stainless steel plate, sheet and strip”. Examples include Q355 steel, Q390 steel, etc., among which, considering factors such as mechanical performance, processability, and cost, Q355C steel is preferred.

The design principle of the preferred chemical composition for base steel is illustrated below.

C: C is an austenite stabilizing element, which plays the role of solid solution strengthening in steel and significantly enhances the strength of the steel. However, excessively high C content adversely affects weldability and toughness, and is also more likely to form hard-phase structures such as pearlite and martensite-austenite islands, which degrades the corrosion resistance performance of the steel. Therefore, to balance strength and toughness of the steel plate and meet the weldability requirements for carbon steel materials, the C content in the carbon steel layer is controlled to be 0.24% or less, preferably 0.03% or more and 0.10% or less.

Si: Si is a deoxidizing element. In addition, Si can be dissolved in ferrite and play the role of solid solution strengthening, significantly improving the strength and hardness of steel. The Si content in the carbon steel layer is controlled to be 0.55% or less, preferably 0.1% or more and 0.3% or less.

Mn: Mn delays the pearlite transformation, lowers the critical cooling rate, and improves the hardenability of the steel. It also acts as a solid solution strengthening element, serving as the primary solid solution strengthening element in steel. However, excessively high Mn content can lead to the formation of segregation bands and martensitic structures, adversely affecting the steel's toughness. At the same time, segregation bands can reduce the steel's corrosion resistance performance. The Mn content in the carbon steel layer is controlled to be 1.6% or less, preferably 1.0% or more and 1.5% or less.

P, S: P and S are common impurity elements in carbon steel. Among them, P increases the hardness of central segregation zones, leading to degradation of HIC resistance, while S typically exists as sulfide inclusions in steel, deteriorating toughness and HIC resistance. Therefore, the contents of P and S should be restricted, preferably 0.035% or less respectively. Preferably, P is 0.01% or less and S is 0.005% or less.

Cr: Cr is an element that reduces the austenite phase region and also a medium-strength carbide-forming element, soluble in ferrite. Cr enhances the stability of austenite, shifting the C-curve to the right, thereby reducing the critical cooling rate and improving the steel's hardenability. Cr also lowers the austenite transformation temperature, causing various carbides such as (Fe, Cr)3C, (Fe, Cr)7C3, and (Fe, Cr)23C7 to precipitate at relatively low temperatures. This refines the structure and carbides, significantly increasing the steel's strength and hardness. However, Cr adversely affects the steel's toughness. Considering these factors, the technical solution of the present invention controls the Cr content in the carbon steel layer to be within 0.30%, preferably 0.24% or more.

Ni: Ni in steel dissolves only in the matrix phases of ferrite and austenite, without forming carbides. It exhibits a strong austenite stabilizing effect and enhances the steel's low-temperature toughness. Therefore, in the technical solution of the present invention, the addition of Ni in the carbon steel layer is controlled to be within 0.3%, preferably 0.1% or more and 0.25% or less.

Cu: Cu in steel primarily exists in the solid solution state and as precipitated elemental phase. Dissolved Cu contributes to solid solution strengthening; since the solubility of Cu in ferrite decreases rapidly with decreasing temperature, supersaturated Cu precipitates as elemental particles at lower temperatures, providing precipitation strengthening. Additionally, adding a small amount of Cu to the carbon steel layer significantly enhances the atmospheric corrosion resistance of the clad steel plate. Therefore, in the technical solution of the present invention, the addition of Cu in the carbon steel layer is controlled to be within 0.40%, preferably 0.1% or more and 0.3% or less.

In the present invention, an appropriate amount of Mo, Ni, V, Nb, Ti, Al, N and other elements can be added to the base layer steel, as needed.

In the present invention, the tensile strength of the base layer steel is typically controlled within the range of 500-620 MPa. This is because when the tensile strength falls below the lower limit, the steel's hardness and ductility may be compromised, while exceeding the upper limit often requires increased C content from a chemical composition perspective, which reduces the steel's plasticity. Generally, during welding, if the C content exceeds 0.4%, measures such as preheating before welding, slow cooling after welding, or heat treatment is required to mitigate the steel plate's harden tendency during welding.

In the present invention, the yield strength of the base layer steel is 300 MPa or more, preferably 350 MPa or more, more preferably 400 MPa or more. While no specific upper limit is imposed, considering factors such as manufacturing costs, practical requirements, and balance with other performance, the yield strength is preferably 500 MPa or less. The tensile strength is 500 MPa or more. While no specific upper limit is imposed, considering factors such as manufacturing costs, practical requirements, and balance with other performance, the tensile strength is preferably 600 MPa or less. The impact energy at 0° C. (KV₂) is 200 J or more, preferably 250 J or more, more preferably 300 J or more. While no specific upper limit is imposed, considering factors such as manufacturing costs, practical requirements, and balance with other performance, the impact energy at 0° C. is generally 400 J or less.

ii. Cladding Layer Composition

In the present invention, the cladding layer is preferably composed of austenitic stainless steel. This ensures that the outer surface of the clad steel plate exhibits corrosion resistance. The specific grade of austenitic stainless steel is not particularly limited, but it preferably complies with “GB/T 3274-2017 Hot rolled stainless steel plate, sheet and strip”. Examples include SUS304L, SUS316L, SUS317L, etc. Among these, SUS304L is preferred due to its low carbon content, superior resistance to intergranular corrosion, and the fact that it does not require heat treatment after welding.

The austenitic stainless steel comprises the following chemical components in mass percentage: 0<C≤0.08%, 0<Si≤1.0%, 0<Mn≤2.0%, Cr: 18.0-20.0%, Ni: 8.0-11.0%, 0<S≤0.03%, 0<P≤0.035%, with the balance being Fe and unavoidable impurities; preferably comprising: C: 0.02-0.045%, Si: 0.3-0.6%, Mn: 1.0-1.4%, Cr: 18.0-19.0%, Ni: 8.0-9.0%, 0<P≤0.03%, 0<S≤0.01%, with the balance being Fe and unavoidable impurities.

The design principles for the preferred chemical composition of the cladding layer steel are illustrated below.

C: C precipitates as carbides at grain boundaries during the thermal processing in the manufacture of clad plate, which deteriorates corrosion resistance. Therefore, the C content should be inhibited to be 0.08% or less, preferably 0.02% or more and 0.045% or less.

Si: Si is a deoxidizing element. If the Si content is too low, its effect becomes insufficient. However, exceeding 1.0% deteriorates corrosion resistance. The Si content is preferably 0.30% or more and 0.60% or less.

Mn: Mn enhances the hardenability of steel and is a key element for forming the austenitic structure. However, excessive Mn content adversely affects the steel's toughness, weldability, HIC resistance, and corrosion resistance. Therefore, the Mn content in the cladding layer should be controlled to be 2.0% or less, preferably 1.0% or more and 1.4% or less.

Cr: Cr improves the hardenability of steel and increases its strength and hardness. Additionally, during tempering, Cr inhibits or slows down the precipitation and aggregation of carbides, enhancing the steel's tempering stability. It also forms a highly protective oxide film on the metal surface, improving pitting corrosion resistance and intergranular corrosion resistance. Furthermore, Cr, when combined with Ni, enhances stress corrosion cracking resistance in acidic environments. Therefore, the Cr content should be 18.0% or more, and considering the balance with other alloys such as Ni, the Cr content should be controlled to be 20.0% or less, preferably 19.0% or less.

Ni: Ni is an element that enhances corrosion resistance, particularly significantly improving stress corrosion cracking resistance in acidic environments. However, due to the high cost of Ni, its content is preferably controlled to be 8.0% or more and 11.0% or less, and more preferably 9.0% or less, considering the balance between corrosion resistance effect and cost.

P, S: P and S are impurity elements that deteriorate corrosion resistance through grain boundary segregation. Therefore, the P content in the cladding layer is preferably 0.035% or more, more preferably 0.030% or less. The S content in the cladding layer is preferably 0.03% or less, more preferably 0.01% or less.

In the present invention, an appropriate amount of Cu, Mo, Al, Ti, N and other elements can be added to the cladding layer steel, as needed.

In the present invention, the yield strength of the cladding layer steel is preferably 400 MPa or more. While no specific upper limit is imposed, considering factors such as manufacturing costs, practical requirements, and balance with other performance, the yield strength is generally 500 MPa or less. The tensile strength is preferably 650 MPa or more. While no specific upper limit is imposed, considering factors such as manufacturing costs, practical requirements, and balance with other performance, the tensile strength is preferably 750 MPa or less. The impact energy at 0° C. (KV₂) is 200 J or more, preferably 250 J or more. While no specific upper limit is imposed, considering factors such as manufacturing costs, practical requirements, and balance with other performance, the impact energy at 0° C. is generally 300 J or less.

iii. Clad Steel Plate Composition

In the clad steel plate of the present invention, the base layer composed of carbon steel or low-alloy steel has a thickness of approximately 40-110 mm. The cladding layer composed of austenitic stainless steel has a thickness of approximately 5-20 mm. The thickness of the clad steel plate is 60-120 mm, preferably 70-100 mm.

It should be noted that at the clad interface between the carbon steel base layer and the stainless steel cladding layer, due to differences in elemental content between the carbon steel base layer and stainless steel cladding layer in the thickness direction, elements with higher concentrations diffuse toward the side with lower concentrations. This results in the formation of a diffusion layer penetrating approximately 5-20 μm into both sides. The average composition of each element within the diffusion layer lies between its respective content in the base layer and cladding layer, exhibiting a gradient transition. For example: alloy elements with higher mass percentages on the stainless steel cladding layer side, such as Cr and Ni, diffuse toward the base layer, while C element with a higher mass percentage in the base layer diffuses toward the cladding layer side. The average composition of C, Cr, and Ni within the diffusion layer lies between their respective concentrations in the stainless steel cladding layer and carbon steel base layer. In the present invention, the average thickness of the diffusion layer is typically between 15-25 μm.

The bonding strength at the joint interface between the base layer and the cladding layer is 500 MPa or more, preferably 550 MPa or more, more preferably 600 MPa or more. While no specific upper limit is imposed, considering factors such as manufacturing costs, practical requirements, and balance with other performance, it is generally 650 MPa or less.

The clad steel plates of Examples 1-7 of the present invention are manufactured through the following steps in sequence:
1) Assembling a slab: Select stainless steel and carbon steel with required thicknesses and compositions respectively, process them to required dimensions, then remove oxide scales and contaminants from the surfaces of the stainless steel and carbon steel. Stack the stainless steel and carbon steel, perform vacuum sealing, bond the four edges of the stainless steel and carbon steel to form a clad slab. Evacuate the clad slab to achieve a vacuum degree of 0.01 Pa or less. The compositions and thicknesses of the stainless steel and carbon steel selected are shown in Table 1.

In the present invention, two of the above double-layer clad slabs can be stacked in the thickness direction with their stainless steel-exposed surfaces facing each other, followed by welding around the edges, a four-layer clad slab is obtained.
2) Heating: Heating the clad slab to 1150-1250° C., with a total furnace time of 300-400 min. After heating, remove it from the furnace and transfer it to a rolling mill for rolling.
3) Rolling: Including a first rolling and a second rolling, preferably only two rolling passes. Wherein, the first rolling adopts longitudinal rolling along the length direction of the clad slab, with the stainless steel as the upper layer and the carbon steel as the lower layer during rolling. After rolling, perform stack cooling;

Then the clad slab is turned over and reheated to 1150-1250° C. and perform second rolling. During rolling, the upper layer is the carbon steel and the lower layer is the stainless steel, resulting in the rolled steel plate.
4) Cooling: First adopting a first-stage cooling on the rolled steel plate using compressed air or water, and then performing stack cooling on the rolled steel plate to obtain the clad steel plate.

In the present invention, the selection of heating temperature comprehensively considers the physical characteristics of austenitic stainless steel and carbon steel. This enables complete or partial dissolution of carbides of elements such as niobium and titanium, promotes uniform distribution of segregated alloy elements that may exist in both the carbon steel and austenitic stainless steel, facilitates complete metallurgical bonding, and ensures the formation of a uniform austenitic structure without austenite grain coarsening.

In the present invention, atomic interdiffusion at the stainless steel-carbon steel interface is achieved through rolling, forming a diffusion layer between the heterogeneous cladding and base layers, thereby obtaining the desired clad steel plate with excellent bonding strength.

In step 2, preferably, during the first rolling, the clad slab is rolled to 1.5-2.5 times the finished thickness, more preferably 1.5-2.0 times the finished thickness.

Preferably, during the first rolling, the clad slab undergoes multi-pass rolling with a reduction rate of 5-10% per pass. A reduction rate of 10% or less avoids steel plate warping during rolling, while multi-pass rolling with a reduction rate of 5% or more ensures sufficient mixing of the structure at the carbon steel-stainless steel clad interface, thereby achieving excellent bonding strength at the clad interface of the steel plate. Preferably, the second rolling is a width extension rolling, specifically subjecting multi-pass rolling to the clad slab with a reduction rate of 10-20% per pass. The finishing rolling temperature is 850-1000° C., preferably 870-950° C., more preferably 890-920° C.

The second rolling employs a relatively large reduction rate to provide sufficient deformation energy storage, ensuring plastic deformation of the material and promoting grain fragmentation and recrystallization. Specifically, this enables the metal atoms at the interface of the composite material to undergo mutual interpenetration via diffusion under adequate compressive stress, achieving atomic-level bonding and sufficient deformation at the interface. The interface undergoes multiple recrystallizations, thereby enhancing the impact performance of the clad steel plate.

The finishing rolling temperature is controlled within 850-1000° C. to ensure rolling occurs above the carbide precipitation temperature of the cladding layer stainless steel and close to the recrystallization temperature range of the austenitic structure in the base layer.

In step 4, preferably, during the first-stage cooling, the starting cooling temperature is 830-1000° C., more preferably 830-880° C., the cooling rate is 5-20° C./s, more preferably 10-20° C./s, and the final cooling temperature is 500-650° C., more preferably 500-580° C. The rolled steel plate is then taken off the line and transferred to a slow cooling pit for centralized stack cooling and is removed from the pit and stacked after cooling to 200° C. or less.

More preferably, water is used to perform the first-stage cooling of the above rolled steel plate, wherein an upper-to-lower water amount ratio is 1:2-1:4, most preferably around 1:3.

### EXAMPLES

The following provides more specific descriptions of the embodiments of the present invention through Examples. However, the Examples below are specific illustrations of the embodiments of the present invention and should not be construed as limiting the scope of the invention in any way. Additionally, unless otherwise specified, all percentages used in this specification are by mass.

### Example 1

Carbon steel Q355C (thickness: 280 mm) from Baoshan Iron & Steel Co. Ltd. was used as the slab for the base layer, and stainless steel SUS304L (00Cr19Ni10; thickness: 50 mm) from Baoshan Iron & Steel Co. Ltd. was used as the slab for the cladding layer. The chemical compositions of the carbon steel and stainless steel are shown in Table 1 below.

The clad slabs were processed according to the process conditions shown in Table 2 below. Specifically as follows.

After surface processing to remove oxide scales and ensure surface roughness and flatness, the cladding layer and the base layer were bonded along all four edges via vacuum sealing, followed by evacuation of the bonded interface to reduce the vacuum degree to below 0.01 Pa, resulting in a final clad slab thickness of 330 mm.

Subsequently, the clad slab was heated and rolled. During the first rolling, the upper layer of the clad slab was stainless steel and the lower layer was carbon steel. The clad slab was heated in a heating furnace to 1220° C., with a total furnace time of 355 min. After heating, it was removed from the furnace and transferred to a rolling mill for rolling. During rolling, a reduction rate per pass was controlled at approximately 8%, ultimately rolling to 220 mm to complete the first rolling. Then, the clad slab was subject to stack cooling.

After cooling, the clad slab was turned over so that the upper layer was the carbon steel and the lower layer was the stainless steel. It was heated in the furnace to the same heating temperature as the first rolling, with a total furnace time of 300 min. After heating, it was removed from the furnace for rolling with a reduction rate of approximately 13% per pass, ultimately rolling the clad slab to around 80 mm. The finishing rolling temperature was controlled at 915° C.

After rolling, water cooling was performed with an upper-to-lower water amount ratio of approximately 1:3. The cooling rate was about 18° C./s, and the final cooling temperature was 612° C. The steel plate was then taken off the line and transferred to a slow cooling pit for centralized stack cooling and was removed from the pit and stacked after cooling to 200° C. or less. The performance of the resulting clad steel plate was determined, and the results are shown in Table 3 below.

Wherein, the grain size grading was conducted as follows: The ferrite structures in both the carbon steel and stainless steel were evaluated for grain size using the intercept method according to GB/T 6394-2017 “Determination of estimating the average grain size of metal”.

The yield strength and tensile strength of the carbon steel and stainless steel were measured in accordance with GB/T 6396-2008 “Clad steel plates-Mechanical and technological test” and GB/T 228-2010 “Metallic materials-Tensile testing-Method of test at room temperature”.

The impact energy at 0° C. (KV₂) (longitudinal direction) of the carbon steel and stainless steel was measured in accordance with GB/T 6396-2008 “Clad steel plates-Mechanical and technological test” and GB/T 229-2020 “Metallic materials-Charpy pendulum impact test method”.

The bonding strength between the cladding and base layers of the clad steel plate was measured in accordance with GB/T 6396-2008 “Clad steel plates-Mechanical and technological test”.

The flaw detection of the clad steel plate was measured in accordance with NB/T 47013.3-2015 “Non-destructive testing of pressure equipments—Part 3: Ultrasonic testing”, using standards specified in Amendment No. 1, new Table 6 and Table 7, Grade I.

The intergranular corrosion resistance of the stainless steel was measured in accordance with GB/T 4334-2000 “Corrosion of metals and alloys-Test methods for intergranular corrosion of stainless steels” (Method E).

### Examples 2-7 and Comparative Examples 1-5

Following substantially the same steps as in Example 1, the clad steel plates of Examples 2-7 and Comparative Examples 1-5 were manufactured using the steels specified in Table 1, and their performance was determined. Specific process conditions and performance results are shown in Table 2 and Table 3.

Table 1 shows the compositions (in wt. %) and thicknesses of the selected stainless steel and carbon steel slabs, wherein the balance of the stainless steel and carbon steel compositions is Fe and unavoidable impurities other than P and S.

TABLE 1

Stainless steel

| No. | C | Si | Mn | Cr | Ni | S | P | Thickness/mm |
|---|---|---|---|---|---|---|---|---|
| 1 | 0.025 | 0.33 | 1.22 | 18.12 | 8.62 | 0.006 | 0.022 | 50 |
| 2 | 0.024 | 0.52 | 1.35 | 18.43 | 8.14 | 0.003 | 0.025 | 45 |
| 3 | 0.034 | 0.44 | 1.33 | 18.67 | 8.34 | 0.005 | 0.023 | 48 |
| 4 | 0.029 | 0.38 | 1.24 | 18.23 | 8.23 | 0.004 | 0.02 | 54 |
| 5 | 0.04 | 0.47 | 1.36 | 18.33 | 8.19 | 0.007 | 0.021 | 60 |

| | Carbon steel | | | | | | | | |
|---|---|---|---|---|---|---|---|---|---|
| No. | C | Si | Mn | Cr | Ni | S | P | Cu | Thickness/mm |
| 1 | 0.034 | 0.22 | 1.24 | 0.23 | 0.12 | 0.001 | 0.007 | 0.20 | 300 |
| 2 | 0.048 | 0.17 | 1.31 | 0.25 | 0.14 | 0.002 | 0.005 | 0.15 | 250 |
| 3 | 0.056 | 0.15 | 1.35 | 0.27 | 0.21 | 0.001 | 0.005 | 0.18 | 280 |
| 4 | 0.046 | 0.23 | 1.26 | 0.25 | 0.17 | 0.002 | 0.006 | 0.19 | 310 |
| 5 | 0.076 | 0.18 | 1.27 | 0.28 | 0.18 | 0.001 | 0.008 | 0.25 | 330 |

Table 2 shows the specific process parameters adopted to manufacture the clad steel plates of Examples 1-7 and Comparative Examples 1-5, as well as the finished thickness of the clad steel plates.

In Table 2, the meaning of the numbering of the clad steel plates is that, for example, the numbering of the clad steel plates adopted is 1-3, referring to the selection of the clad steel plates of stainless steel numbered 1 in Table 1 and carbon steel numbered 3 in Table 1.

Table 3 shows the metallographic structure, mechanical performance of the carbon steel and stainless steel layers, and the thickness of the diffusion layer for the clad steel plates in Examples 1-7 and Comparative Examples 1-5.

The stainless steel in the clad steel plate consists of austenite, while the carbon steel has a structure of polygonal ferrite, bainite, and a small amount of martensite-austenite islands, with volume fractions of approximately 40-60% polygonal ferrite, 30-50% bainite, and 5-10% martensite-austenite islands. Due to the significant difference in Fe content between the base and cladding layers, the Fe element on two sides of the interface before cladding shows a stepwise change. After rolling and cladding the steel plate of the present invention, the Fe element near the clad interface exhibits a continuous variation, indicating Fe diffusion from the carbon steel to the stainless steel so that the Fe content in the carbon steel near the interface becomes lower than that in the carbon steel matrix, while the Fe content in the stainless steel near the interface becomes higher than that in the stainless steel matrix. Therefore, the diffusion layer thickness is defined as the length of the Fe content transition zone near the clad interface. In the present invention, the first boundary of the diffusion layer is defined as the position in the carbon steel where the Fe content decreases by 5% compared to the matrix. The second boundary is defined as the position in the stainless steel where the Fe content increases by 5% compared to the matrix. The thickness of the diffusion layer is defined as the distance between the first and second boundaries.

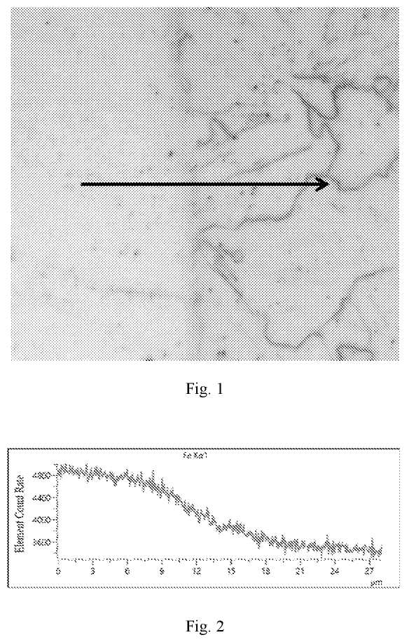

FIG. 1 shows a photograph of the interface of the clad steel plate in Example 1 of the present invention. FIG. 2 shows the results of Fe element line scanning along the arrow direction on the steel plate indicated in FIG. 1. The element count rate (in CPS, COUNTS PER SECOND) indicates the relative content of elements at each position, and the line scanning results reflect the trend of elemental content variation along the straight line. The results show that the average thickness of the diffusion layer in the clad steel plate of Example 1 is approximately 18 μm. The average thickness of the diffusion layer in the present invention is the average of the diffusion layer thickness obtained from Fe element line scanning at 10 different positions within the field of view.

TABLE 2

| | | | | | Step 3 | | | | | | | |
|---|---|---|---|---|---|---|---|---|---|---|---|---|
| | | | | | Reduction | | Reduction | Fin- | Step 4 | | | |
| | | Step 1 | | | rate | Thick- | rate | ishing | Starting | | Final | |
| | Clad | Thick- | Step 2 | | per pass | ness | per pass | rolling | cooling | | cooling | Fin- |
| | steel | ness | | Total | during | after | during | temper- | temper- | Cooling | temper- | ished |
| | plate | of clad | Heating/° | furnace | first | first | second | ature/° | ature/° | rate/[° | ature/° | thick- |
| | No. | slab/mm | C. | time/min | rolling/% | rolling/mm | rolling/% | C. | C. | C./s] | C. | ness/mm |
| Example 1 | 1-3 | 330 | 1220 | 355 | 8 | 220 | 13 | 915 | 880 | 18 | 612 | 96 |
| Example 2 | 2-4 | 355 | 1223 | 362 | 7 | 210 | 13 | 900 | 875 | 15 | 578 | 90 |
| Example 3 | 4-2 | 304 | 1231 | 324 | 9 | 160 | 14 | 895 | 870 | 16 | 545 | 65 |
| Example 4 | 5-5 | 390 | 1195 | 367 | 5 | 200 | 11 | 897 | 846 | 7 | 598 | 115 |
| Example 5 | 4-1 | 354 | 1193 | 398 | 6 | 205 | 12 | 907 | 857 | 8 | 599 | 100 |
| Example 6 | 3-5 | 378 | 1202 | 395 | 8 | 197 | 14 | 918 | 876 | 13 | 559 | 86 |
| Example 7 | 2-3 | 325 | 1245 | 361 | 6 | 150 | 15 | 914 | 831 | 10 | 604 | 70 |
| Comparative | 1-5 | 380 | 1198 | 400 | 3 | 220 | 6 | 920 | 890 | 2 | 850 | 85 |
| Example 1 | | | | | | | | | | | | |
| Comparative | 3-3 | 328 | 1205 | 378 | 6 | 195 | 5 | 980 | 930 | 5 | 740 | 102 |
| Example 2 | | | | | | | | | | | | |
| Comparative | 3-5 | 378 | 1204 | 390 | 8 | 200 | 12 | 1010 | 950 | 2 | 940 | 112 |
| Example 3 | | | | | | | | | | | | |
| Comparative | 4-3 | 334 | 1211 | 387 | 5 | 260 | 14 | 810 | 760 | 22 | 480 | 79 |
| Example 4 | | | | | | | | | | | | |
| Comparative | 5-2 | 310 | 1221 | 365 | 2 | 170 | 7 | 950 | 860 | 17 | 510 | 95 |
| Example 5 | | | | | | | | | | | | |

TABLE 3

| | Average | | | | | | | | |
|---|---|---|---|---|---|---|---|---|---|
| | thickness | Metallographic | | Grain size grade | | | | | |
| | of the | structure | | Ferrite in | Austenite in | Yield strength/MPa | | | |
| | diffusion | Carbon | Stainless | carbon | stainless | Carbon steel | | Stainless steel | |
| | layer/μm | steel | steel | steel | steel | Transverse | Longitudinal | Transverse | Longitudinal |
| Example 1 | 18 | Polygonal | Austenite | 5.5-6 | 3-5 | 450 | 429 | 414 | 403 |
| Example 2 | 17 | ferrite + | Austenite | 5-6 | 3-5 | 423 | 423 | 420 | 421 |
| Example 3 | 19 | bainite + | Austenite | 6-7 | 4-5 | 488 | 491 | 408 | 417 |
| Example 4 | 21 | small | Austenite | 5-6.5 | 3-5 | 429 | 437 | 456 | 466 |
| Example 5 | 18 | amount of | Austenite | 5-6.5 | 3-5 | 423 | 434 | 413 | 423 |
| Example 6 | 19 | martensite- | Austenite | 6-7 | 4-5 | 491 | 495 | 421 | 416 |
| Example 7 | 20 | austenite | Austenite | 5-5.5 | 3-5 | 437 | 457 | 431 | 422 |
| | | islands | | | | | | | |
| Comparative | 11 | Polygonal | Austenite | 4-5 | 3-4 | 345 | 346 | 390 | 402 |
| Example 1 | | ferrite | | | | | | | |
| Comparative | 14 | Acicular | Austenite | 5-5.5 | 3-4.5 | 403 | 430 | 420 | 430 |
| Example 2 | | ferrite + | | | | | | | |
| | | bainite + | | | | | | | |
| | | small | | | | | | | |
| | | amount of | | | | | | | |
| | | martensite- | | | | | | | |
| | | austenite | | | | | | | |
| | | islands | | | | | | | |
| Comparative | 18 | Polygonal | Austenite | 5-6 | 3-5 | 378 | 388 | 390 | 387 |
| Example 3 | | ferrite | | | | | | | |
| Comparative | 17 | Bainite + | Elongated | 6-6.5 | 2.5-4 | 520 | 544 | 610 | 580 |
| Example 4 | | small | austenite | | | | | | |
| | | amount of | | | | | | | |
| | | martensite- | | | | | | | |
| | | austenite | | | | | | | |
| | | islands | | | | | | | |
| Comparative | 14 | Polygonal | Austenite | 4-4.5 | 2.5-4.5 | 410 | 412 | 423 | 434 |
| Example 5 | | ferrite + | | | | | | | |
| | | bainite + | | | | | | | |
| | | small | | | | | | | |
| | | amount of | | | | | | | |
| | | martensite- | | | | | | | |
| | | austenite | | | | | | | |
| | | islands | | | | | | | |

| | | | | | Impact energy | | | | |
|---|---|---|---|---|---|---|---|---|---|
| | | | | | at 0° C. | | | | |
| | | | | | KV₂/J | | | Flaw | |
| | Tensile strength/MPa | | | | (Longitudinal) | | | detection | |
| | Carbon steel | | Stainless steel | | Carbon | Stainless | Bonding | pass | Intergranular |
| | Transverse | Longitudinal | Transverse | Longitudinal | steel | steel | strength/MPa | rate | corrosion |
| Example 1 | 557 | 549 | 693 | 674 | 308 | 288 | 596 | 100% | No |
| Example 2 | 547 | 549 | 681 | 685 | 369 | 240 | 572 | 100% | No |
| Example 3 | 583 | 570 | 664 | 671 | 378 | 256 | 565 | 100% | No |
| Example 4 | 549 | 559 | 712 | 720 | 389 | 262 | 584 | 100% | No |
| Example 5 | 549 | 558 | 656 | 678 | 372 | 274 | 590 | 100% | No |
| Example 6 | 570 | 583 | 686 | 685 | 375 | 246 | 577 | 100% | No |
| Example 7 | 559 | 553 | 691 | 701 | 380 | 255 | 576 | 100% | No |
| Comparative | 478 | 482 | 623 | 610 | 290 | 210 | 230 | 99% | Corrosion |
| Example 1 | | | | | | | | | occurred |
| Comparative | 588 | 574 | 644 | 632 | 310 | 234 | 450 | 100% | No |
| Example 2 | | | | | | | | | |
| Comparative | 467 | 478 | 590 | 598 | 210 | 198 | 560 | 100% | Corrosion |
| Example 3 | | | | | | | | | occurred |
| Comparative | 602 | 610 | 689 | 654 | 195 | 170 | 540 | 100% | No |
| Example 4 | | | | | | | | | |
| Comparative | 549 | 569 | 656 | 670 | 310 | 267 | 345 | 98% | No |
| Example 5 | | | | | | | | | |

As shown in Table 3, the total thickness of the clad steel plate obtained by the manufacture process of the present invention is from 60-120 mm, wherein the diffusion layer thickness is between 17-21 μm. The metallographic structure of the stainless steel in the steel plate is austenite, wherein the austenite has a grain size grade between 3-5, the yield strength is 400-600 MPa, and the tensile strength is 650-850 MPa. The metallographic structure of the carbon steel is polygonal ferrite+bainite+a small amount of martensite-austenite islands, wherein the grain size grade of ferrite is between 5-7, the yield strength is 300-500 MPa, the tensile strength is 500-600 MPa, and the impact energy at 0° C. is 200-400 J. No defects/flaws were detected at the interface between cladding and base metal (diffusion layer) in the clad steel plate of Examples 1-7, achieving 100% flaw detection pass rate. None of the stainless steel in Examples 1-7 exhibited intergranular corrosion.

Comparative Example 1 failed to meet the requirements for grain size, intergranular corrosion, and bonding strength due to the reduction rates during first and second rolling and cooling rates being outside the ranges specified in the present invention.

Comparative Example 2 failed to meet the requirement for bonding strength due to the reduction rate during second rolling being outside the ranges specified in the present invention.

Comparative Example 3 failed to meet the requirement for intergranular corrosion due to the finishing rolling temperature, final cooling temperature, and cooling rate being outside the ranges specified in the present invention.

Comparative Example 4 failed to meet the requirement of impact performance due to the finishing rolling temperature, start cooling temperature, and final cooling temperature being outside the ranges specified in the present invention.

Comparative Example 5 failed to meet the requirements of grain size and bonding strength due to the reduction rate during rolling being outside the ranges specified in the present invention.

Through the manufacturing method of the present invention, particularly through the control of rolling and cooling processes, the bonding strength at the interface between the base layer and cladding layer of the steel plate is 550-650 MPa. The clad steel plate exhibits excellent flatness, outstanding mechanical performance, and corrosion resistance.

The manufacturing method of the present invention is simple and practical, making it highly suitable for large-scale production of heterogeneous clad steel plates for hydropower applications.

It should be noted that all technical features described in the present invention can be freely combined or integrated in any manner unless they contradict each other. Various modifications and variations to the invention may be made without departing from its scope, as will be obvious to those skilled in the art. For example, features shown or described as part of one embodiment can be combined with another embodiment to yield a further embodiment. Accordingly, the present invention is intended to cover such modifications falling within the scope of the appended claims and their equivalents.

1. A clad steel plate, comprising a base layer and a cladding layer on the base layer, wherein the clad steel plate has a thickness of 60-120 mm,
the cladding layer is made of stainless steel, and the stainless steel comprises the following chemical components in mass percentage: 0<C≤0.08%, 0<Si≤1.0%, 0<Mn≤2.0%, Cr: 18.0-20.0%, Ni: 8.0-11.0%, 0<S≤0.03%, 0<P≤0.035%, with the balance being Fe and unavoidable impurities; the base layer is made of carbon steel, and the carbon steel comprises the following chemical components in mass percentage: 0<C≤0.24%, 0<Si≤0.55%, 0<Mn≤1.60%, 0<P≤0.035%, 0<S≤0.035%, 0<Cr≤0.30%, 0<Ni≤0.30%, 0<Cu≤0.40%, with the balance being Fe and unavoidable impurities,
and a bonding strength between the base layer and the cladding layer is 500 MPa or more.

2. The clad steel plate according to claim 1, wherein the cladding layer comprises the following chemical components in mass percentage: C: 0.02-0.045%, Si: 0.30-0.60%, Mn: 1.0-1.4%, Cr: 18.0-19.0%, Ni: 8.0-9.0%, 0<P≤0.03%, 0<S≤0.01%, with the balance being Fe and unavoidable impurities; and/or
the base layer comprises the following chemical components in mass percentage: C: 0.03-0.10%, Si: 0.1-0.3%, Mn: 1.0-1.5%, 0<P≤0.01%, 0<S≤0.005%, Cr: 0.24-0.30%, Ni: 0.10-0.25%, Cu: 0.1-0.3%, with the balance being Fe and unavoidable impurities.

3. The clad steel plate according to claim 1, wherein the cladding layer has an austenitic structure, and the base layer has a structure of polygonal ferrite, bainite, and martensite-austenite islands with a volume fraction smaller than either the polygonal ferrite or bainite.

4. The clad steel plate according to claim 3, wherein in the base layer, the ferrite has a volume fraction of 40-60%, the bainite has a volume fraction of 30-50%, the martensite-austenite islands have a volume fraction of 5-10%; and/or, the ferrite has a grain size grade of 5 or more.

5. The clad steel plate according to claim 1, wherein a diffusion layer exists between the base layer and the cladding layer, and the diffusion layer has an average thickness of 15-25 μm.

6. The clad steel plate according to claim 1, wherein the base layer has a yield strength of 300-550 MPa, a tensile strength of 500-600 MPa, and an impact energy at 0° C. of 200-400 J; and/or
the cladding layer has a yield strength of 400-500 MPa, a tensile strength of 650-750 MPa, and an impact energy at 0° C. of 200-300 J.

7. The clad steel plate according to claim 1, wherein the bonding strength of an interface between the base layer and the cladding layer is 550-650 MPa.

8. A method for manufacturing the clad steel plate as claimed in claim 1, comprising the following steps in sequence:
1) Assembling a slab: Preparing stainless steel and carbon steel, stacking the stainless steel and carbon steel after dimensional processing, vacuum sealing to obtain a clad slab, and evacuating the clad slab to a vacuum degree of 0.01 Pa or less;
2) Heating: Heating the clad slab to 1150-1250° C.;
3) Rolling: Including a first rolling and a second rolling, wherein
the first rolling adopts longitudinal rolling, and the upper layer is the stainless steel and the lower layer is the carbon steel during rolling;
then the clad slab is turned over so that the upper layer is the carbon steel and the lower layer is the stainless steel, and the second rolling is performed to obtain a rolled steel plate;
4) Cooling: First adopting a first-stage cooling on the rolled steel plate using compressed air or water, and then performing stack cooling on the rolled steel plate to obtain the clad steel plate;
wherein the first rolling is a multi-pass rolling, and each pass has a reduction rate of 5-10%.

9. The method according to claim 8, wherein the second rolling is a multi-pass rolling, each pass has a reduction rate of 10-20%, and a finishing rolling temperature is 850-1000° C.

10. The method according to claim 8, wherein the first-stage cooling has a starting cooling temperature of 830-1000° C., a cooling rate of 5-20° C./s, and a final cooling temperature of 500-650° C.

11. The method according to claim 10, wherein the first-stage cooling has a starting cooling temperature of 830-880° C., a cooling rate of 10-20° C./s, and a final cooling temperature of 500-580° C.

12. The method according to claim 8, wherein water is used in the cooling step to perform the first-stage cooling of the rolled steel plate, with an upper-to-lower water amount ratio of 1:2-1:4, then the steel plate is transferred to a slow cooling pit for centralized stacking, and then removed from the pit for stacking after cooling to 200° C. or less.

13. The clad steel plate according to claim 2, wherein the base layer has a yield strength of 300-550 MPa, a tensile strength of 500-600 MPa, and an impact energy at 0° C. of 200-400 J; and/or the cladding layer has a yield strength of 400-500 MPa, a tensile strength of 650-750 MPa, and an impact energy at 0° C. of 200-300 J.

14. The clad steel plate according to claim 3, wherein the base layer has a yield strength of 300-550 MPa, a tensile strength of 500-600 MPa, and an impact energy at 0° C. of 200-400 J; and/or the cladding layer has a yield strength of 400-500 MPa, a tensile strength of 650-750 MPa, and an impact energy at 0° C. of 200-300 J.

15. The clad steel plate according to claim 4, wherein the base layer has a yield strength of 300-550 MPa, a tensile strength of 500-600 MPa, and an impact energy at 0° C. of 200-400 J; and/or the cladding layer has a yield strength of 400-500 MPa, a tensile strength of 650-750 MPa, and an impact energy at 0° C. of 200-300 J.

16. The clad steel plate according to claim 5, wherein the base layer has a yield strength of 300-550 MPa, a tensile strength of 500-600 MPa, and an impact energy at 0° C. of 200-400 J; and/or the cladding layer has a yield strength of 400-500 MPa, a tensile strength of 650-750 MPa, and an impact energy at 0° C. of 200-300 J.

17. The clad steel plate according to claim 2, wherein the bonding strength of an interface between the base layer and the cladding layer is 550-650 MPa.

18. The clad steel plate according to claim 3, wherein the bonding strength of an interface between the base layer and the cladding layer is 550-650 MPa.

19. The clad steel plate according to claim 4, wherein the bonding strength of an interface between the base layer and the cladding layer is 550-650 MPa.

20. The clad steel plate according to claim 5, wherein the bonding strength of an interface between the base layer and the cladding layer is 550-650 MPa.
